(19) United States
(12) Patent Application Publication
(10) Pub. No.: US 2006/0219665 A1
(43) Pub. Date: Oct. 5, 2006

(54) Control arrangement for switchgear

(76) Inventors: Yujian Zhou, Buffalo Grove, IL (US); Raphael H. Guio, Barrington, IL (US); Joseph P. Moninski, Arlington Heights, IL (US)

Correspondence Address: James V. Lapacek;S & C Electric Co., 6601 N. Ridge Blvd., Chicago, IL, 60626, US

(21) Appl. No.: 11/324,968

(22) Filed: Jan. 3, 2006

Related U.S. Application Data
(60) Provisional application No. 60/645,829, filed on Jan. 24, 2005.

(51) Int. Cl. H01H 33/66

(52) U.S. Cl. 218/122

(57) ABSTRACT

A control arrangement is provided for an array of circuit interrupters that includes mounting and handling features to transport the array of circuit interrupters between various operating positions within the enclosure. In a specific arrangement, the control arrangement also provides for transporting of the array of circuit interrupters to a position to the exterior of the enclosure. In a specific arrangement, the circuit interrupters are modular and removable from the array. In a preferred arrangement, viewing facilities are provided to observe the array of circuit interrupters to verify the operating positions of the circuit interrupters, specifically, the disconnected and grounded positions. Additionally, a grounded position internal to the enclosure avoids the necessity of manually attaching grounds. In a preferred arrangement, detection of the operational states of the circuit interrupters is also provided in the various positions.

This application claims the benefit of U.S. Provisional Application No. 60/645,829filed on Jan. 24, 2005.

### BACKGROUND OF THE INVENTION

1. Field of the Invention

The present invention relates generally to a control arrangement for an array of articles to transport the articles between various operating positions and detect the operational state of the articles; e.g. an array of circuit interrupters is movable between circuit connected, circuit disconnected and a grounded position within a switchgear enclosure and movable out of the enclosure to an inspection and servicing position.

2. Description of the Related Art

Various switchgear arrangements are known in the prior art for containing and handling electrical articles such as fuses and other circuit interrupters. For example, U.S. Pat. No. 4,777,559 is directed to an arrangement for transporting an array of fuses or the like between a position outside the enclosure to a position internal to the enclosure, and between circuit-connected and disconnected positions within the enclosure. The arrangements of U.S. Pat. Nos. 5,521,567 and 6,040,538include provisions for viewing the connected, disconnected and grounded positions of a switch inside an enclosure.

Additional switchgear operating and handling arrangements are shown in U.S. Pat. Nos. 4,463,227; 4,250,357; 4,190,755; 3,991,348; 3,790,861; 3,748,261; 3,576,509; 3,573,560; and 3,339,118. The arrangement in U.S. Pat. No. 4,463,227is directed to a mounting for an article affixed to one surface of a panel with the panel being simultaneously moved and translated or pivoted end-for-end or side-for-side relative to an opening to selectively move the article between the two locations. The panel covers or blocks the opening in both the locations of the article.

U.S. Pat. No. 4,250,357 discloses a fuse mounting on a back side of a panel with the panel being hinged at the bottom of the enclosure wall to gain access to each fuse. The panel is unlatched and rotated outwardly and downwardly on its hinge until the fuse is accessibly located in a horizontal position immediately in front of the opening normally covered by the panel.

U.S. Pat. Nos. 3,790,861, 3,576,509 and 3,573,560 are directed to horizontally slidable fuse drawers or carriers. U.S. Pat. No. 3,991,348 is directed to a tool and cooperating enclosure arrangement with insertion of the tool opening an access port, isolating the fuse and engaging the fuse so it can be removed.

U.S. Pat. No. 4,190,755 discloses a slidably mounted, switch-operating mechanism mounted on rollers which roll on tracks on upper and lower mounting brackets extending from the enclosure. The arrangement provides certain uncoupling, drawout and interlocking features.

While the above-described arrangements of the prior art are generally suitable for their intended purpose, it would be desirable to provide for the viewing of a planar array of articles between various operating position within an enclosure and the capability to withdraw the planar array from the enclosure for servicing and the like.

### SUMMARY OF THE INVENTION

Accordingly, it is a principal object of the present invention to provide a control arrangement for use with an enclosure to provide movement and viewing of a planar array of articles between various operating positions within an enclosure and the capability to withdraw the planar array from the enclosure for servicing and the like.

It is another object of the present invention to provide a handling and mounting arrangement for transporting an array of circuit interrupters between various operating positions within an enclosure and a position outside the enclosure, the circuit interrupters being modular and removable from the array.

It is a further object of the present invention to provide an arrangement to detect the operational state of an array of circuit interrupters in a number of different operating positions of the array.

These and other objects of the present invention are efficiently achieved by a control arrangement for an array of circuit interrupters that includes mounting and handling features to transport the array of circuit interrupters between various operating positions within the enclosure. In a specific arrangement, the control arrangement also provides for transporting of the array of circuit interrupters to a position to the exterior of the enclosure. In a specific arrangement, the circuit interrupters are modular and removable from the array. In a preferred arrangement, viewing facilities are provided to observe the array of circuit interrupters to verify the operating positions of the circuit interrupters, specifically, the disconnected and grounded positions. Additionally, a grounded position internal to the enclosure avoids the necessity of manually attaching grounds. In a preferred arrangement, detection of the operational states of the circuit interrupters is also provided in the various positions.

### BRIEF DESCRIPTION OF THE DRAWING

The invention, both as to its organization and method of operation, together with further objects and advantages thereof, will best be understood by reference to the specification taken in conjunction with the accompanying drawing in which:

FIG. 1-3 are perspective views of a switchgear enclosure incorporating the control arrangement of the present invention with illustrative circuit interrupters;

FIGS. 4-6 are left-side elevational views, with parts removed for clarity, of circuit-connected, disconnected, and grounded operating positions of the control arrangement of FIG. 1;

FIGS. 7-9 are perspective views of portions of the control arrangement of FIGS. 1-6 illustrating the sensing of the operational state of the circuit interrupters;

FIG. 10 is a diagrammatic representation of portions of the control arrangement of FIG. 1-9 illustrating the sensing of the operational state of the circuit interrupters; and

FIG. 11 is a block diagram of portions of the control arrangement of FIGS. 1-10.

### DETAILED DESCRIPTION

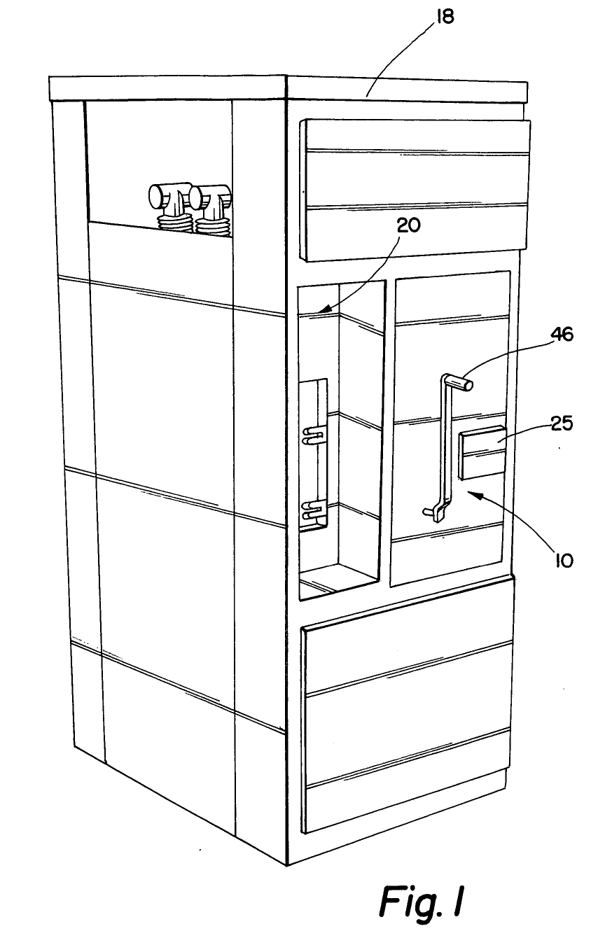

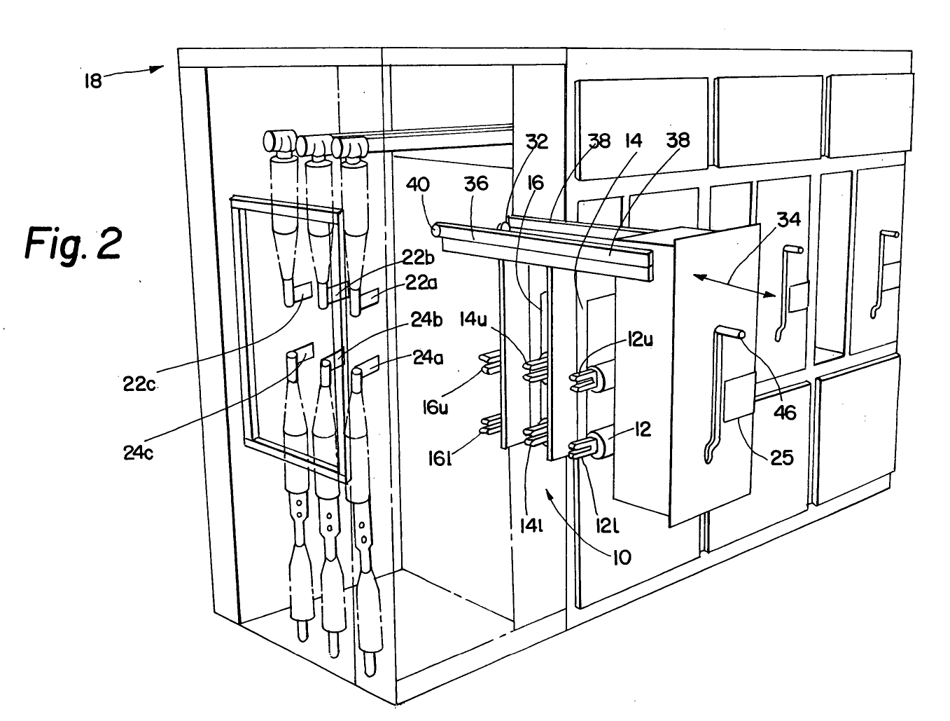

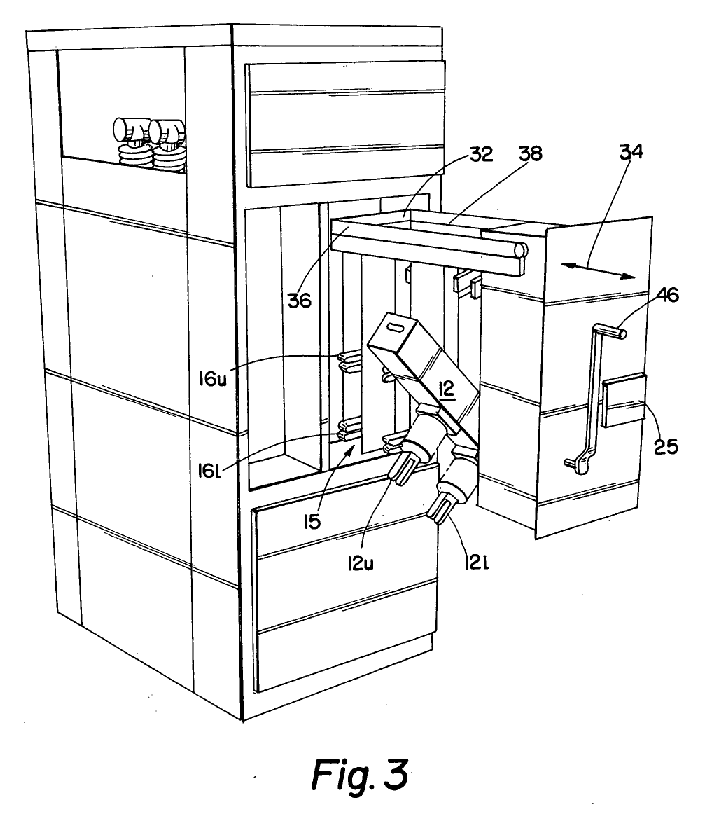

Referring now to FIGS. 1, 2 and 3, the control arrangement 10 of the present invention controls the operating positions of an array 15 (FIGS. 2 and 3) of circuit interrupters 12, 14, 16 within an enclosure 18. The enclosure 18 includes viewing facilities, e.g. a window 20, through which the positions of the array 15 may be viewed and verified, e.g. as required by operating practice in the electrical power distribution industry to perform certain operations.

In a preferred embodiment, as illustrated in FIGS. 2 and 3, the control arrangement 10 includes facilities for transporting the array 15 to a position external to the enclosure 18 e.g. for servicing etc. whereat the circuit interrupters 12, 14, 16 may be removed from the array 15, e.g. via release with respect to article retention clamps 17 (FIG. 3). Also in a preferred embodiment, the circuit interrupters 12, 14, 16 include an actuator and an interrupter (not shown), e.g. vacuum interrupters.

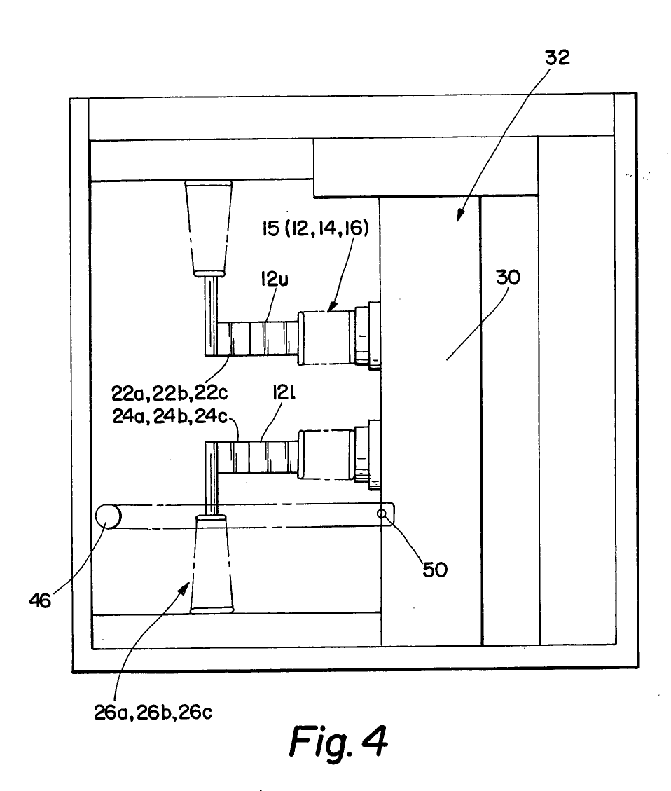

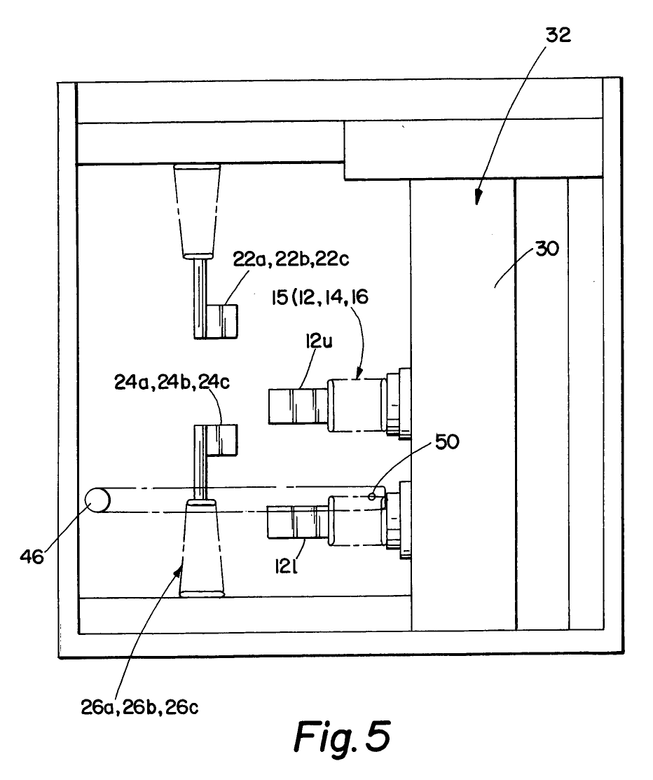

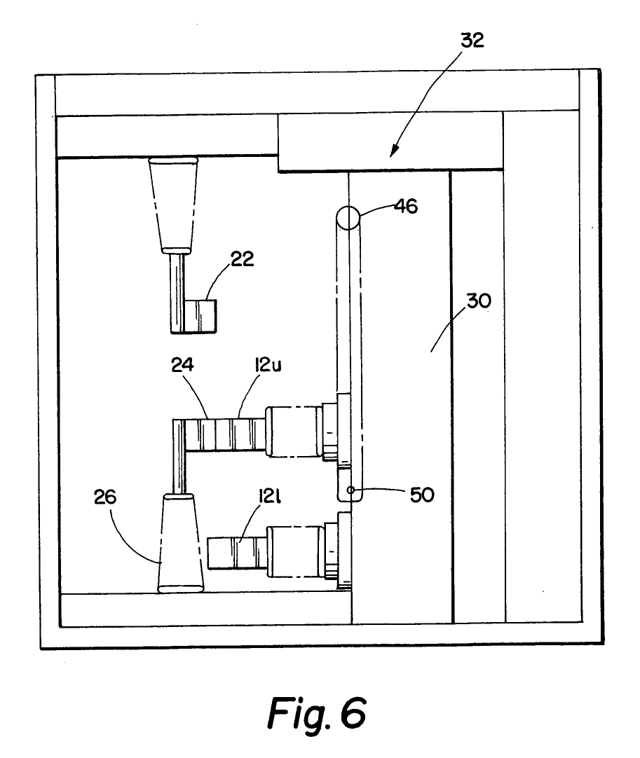

In the preferred embodiment and with additional reference now to FIGS. 4-6, the array 15 is transported between circuit connected (FIG. 4), circuit disconnected (FIG. 5) and grounded positions (FIG. 6) of the circuit interrupters 12, 14, 16, e.g. the circuit interrupters 12, 14, 16 having electrical contacts 12u,l, 14u,l, and 16u,l being respectively connected to electrical contacts 22a,b,c, and 24a,b,c in the circuit connected position, totally isolated in the disconnected position, and the contacts 12u,l, 14u,l, 16u,l being respectively connected to contacts 24a,b,c and ground contacts 26a,b,c in the grounded position.

It should be noted that in the disconnected position of FIG. 5, a “visible air gap” is provided to satisfy operating practices that is observable from the outside of the enclosure 18. Additionally, the grounded position of the circuit interrupters in FIG. 6 is also observable from the outside of the enclosure, again necessary to satisfy operating practices before performing operations on circuit connected thereto. Further, operating controls 25 are provided to operate the circuit interrupters 12, 14, 16 between open and closed circuit positions or states. The circuit interrupters are also operable in response to detected overcurrent conditions to automatically operate. The circuit interrupters 12, 14, 16 are closed in the circuit-connected position of the array 15 to provide circuit continuity and opened to provide disconnection or interruption of the circuit. Further, the circuit interrupters 12, 14, 16 when in the grounded position are closed to provide the grounding of the circuit. Thus, it should be understood that the circuit interrupters 12, 14, 16 are arranged to be opened before moving the array 15 between positions and closed when in a particular position to achieve circuit connection in the connected position and circuit grounding in the grounded position such that the grounding or connecting is effected through the circuit interrupters 12, 14, 16 that include such capabilities and ratings. It should also be noted that in the circuit-disconnected position of the array 15, when the circuit interrupters 12, 14, 16 are in the open position or state, two open gaps are provided between any of the electrical contacts, a first open gap between the contacts 22,24 and the array of circuit interrupters and a second within each of the circuit interrupters 12, 14, 16.

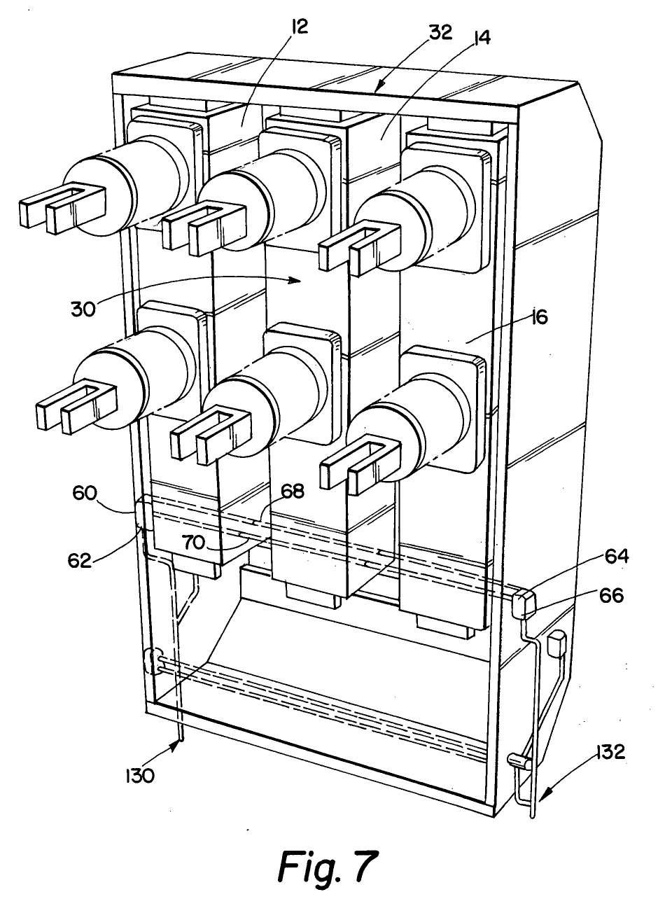

In the illustrative embodiment, the control arrangement 10 includes a cradle 30 for supporting the array 15 of the circuit interrupters 12, 14, 16. The cradle 30 and circuit interrupters 12, 14, 16 are also shown in FIG. 7 removed from the other portions of the control arrangement 10. The cradle 30 also may be characterized as a mounting array. Specifically, the cradle 30 is supported with respect to a mounting frame 32 and movable with respect to the mounting frame 32 between the circuit connected, circuit disconnected and grounded positions. In the preferred embodiment, in addition to the circuit connected position of FIG. 4 and the grounded position of FIG. 6, the cradle 30 is also movable between the disconnected position of FIG. 5 within the enclosure 18 to a position outside the enclosure 18 as shown in FIG. 2 and 3, e.g. via translation of the mounting frame 32 along an axis 34. For example, in an illustrative embodiment, the mounting frame 32 includes rails 36, 38 that support or suspend the mounting frame 32 with respect to the enclosure 18 for translation of the mounting frame 32, the cradle 30 and the array 15 along the axis 34 with respect to the enclosure 18. For example, the rails 36, 38 move with respect to rollers as shown at 40.

Considering now further aspects of the control arrangement 10 regarding the movement of the cradle 30 for the array 15 between the circuit connected, circuit disconnected and grounded positions, in a specific implementation, the cradle 30 is suspended from the mounting frame 32 via upper links 42, 44 (FIG. 5) at either end of the cradle 30. An operating handle 46 is attached to the cradle at a drive input point 50 and is coupled to drive the cradle 30 via lower drive links 52, 54 arranged at either end of the cradle 30. With the cradle within the enclosure 18 and in the circuit-connected position of FIG. 4, the operating handle 46 is inserted and rotated clockwise approximately 90 degrees to move the cradle 30 to the disconnected position of FIG. 5. The operating handle 46 may be removed without further operation, or the operating handle 46 may be reinserted in the position as shown in FIG. 5 and rotated 90 degrees to move the cradle 30 to the grounded position of FIG. 6. Of course, in the disconnected position, the operating handle 46 could also be rotated counterclockwise 90 degrees to move the cradle 30 back to the circuit-connected position. In the grounded position of FIG. 6, again, the operating handle 46 may be removed or the handle rotate 90 degrees counterclockwise to move the cradle 30 to the disconnected position.

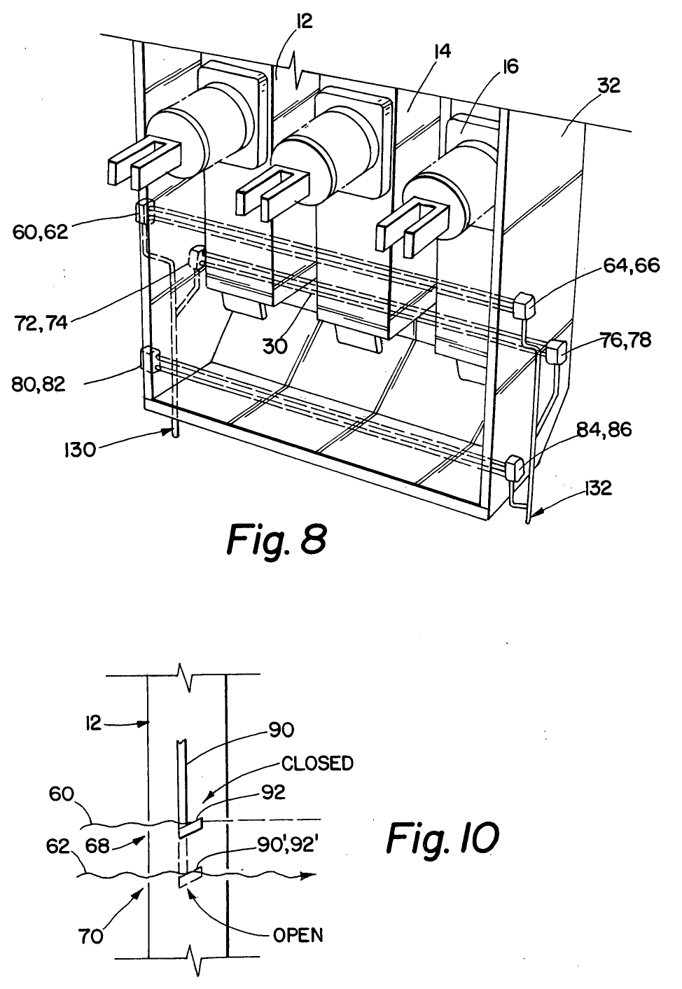

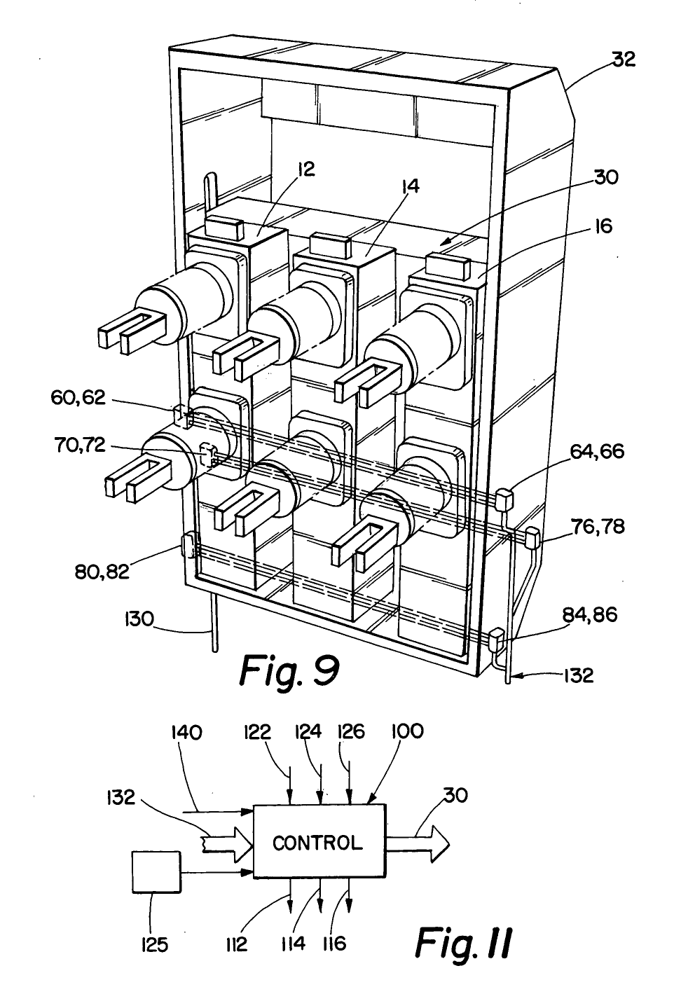

Considering other aspects of the present invention and with reference to FIGS. 7-9, the control arrangement 10 includes facilities to detect the operational state of the array 15 of the circuit interrupters 12, 14, 16 in the various operating positions thereof. To this end, in a specific implementation, optical sensor arrangements are provided corresponding to each of the operating positions of the array 15, i.e. circuit connected, disconnected and grounded. However, it should be realized that in other specific implementations, various other signal media could be utilized for the sensing function. A pair of optical transmitters and receptors is provided, namely upper and lower transmitters 60, 62 at one side of the cradle 30 and upper and lower receptors 64, 66 at the other side of the cradle 30 being aligned with holes or windows on each side of each of the circuit interrupters 12, 14, 16, e.g. upper and lower windows 68,70 when the array 15 is in the circuit-connected position, such that the beam from the optical transmitters can pass through the upper windows 68 when the circuit interrupters 12, 14, 16 are opened and pass through the lower windows 70 when the circuit interrupters 12, 14, 16 are closed.

Similarly, upper and lower transmitters 72, 74 and upper and lower receptors 76, 78 are provided to detect the operational state of the interrupters 12, 14, 16 when the array 15 is in the disconnected position, and upper and lower transmitters 80, 82 and upper and lower receptors 84, 86 are provided to detect the operational state of the interrupters 12, 14, 16 when the array 15 is in the grounded position. Referring now additionally to FIG. 10, an operating plunger 90 of each of the circuit interrupters 12, 14, 16 includes a shutter portion 92 (shown in the closed position in FIG. 10) that is effective in the closed position to block light from upper transmitter 60. In the open position, the plunger 90 moves to the position 90′ whereupon the shutter 92 blocks the light from the lower transmitter 62. Thus, if light is blocked for both receptors of a pair, one or more of the circuit interrupters 12, 14, 16 is out of synchronization with respect to the others as to operational state.

With reference now additionally to FIG. 11, the control arrangement includes control facilities referred to at 100. The control 100 includes outputs 112, 114, 116 to control the circuit interrupters 12, 14 16, e.g. for opening and closing operations and also receives inputs at 122, 124, 126 from the circuit interrupters 12, 14, 16, e.g. sensed circuit parameters. The control 100 also includes outputs at 130 to operate the optical transmitters 60, 62, 72, 74, 80, 82. Additionally, the control at inputs 132 receives the outputs of the optical receptors 64, 66, 76, 78, 84, 86 to detect the operational status of the circuit interrupters 12, 14, 16. For example, the control 100 utilizes the signals from each receptor pair at each operating position, i.e. a signal from the upper receptor of the pair and no signal from the lower receptor representing an open state of the respective circuit interrupter. Conversely, a signal from the lower receptor of the pair and no signal from the upper receptor representing a closed state of the respective circuit interrupter. In accordance with additional features of the control arrangement 10, the control 100 is arranged to operate the optical transmitters only when desired or needed, i.e. operate the transmitters and poll the receptors after specific events occur or based on initiated queries, e.g. responsive to an input 140.

While there has been illustrated and described a preferred embodiment of the present invention, it will be apparent that various changes and modifications will occur to those skilled in the art. Accordingly, it is intended in the appended claims to cover all such changes and modifications that fall within the true spirit and scope of the present invention.

1. A control arrangement used with an enclosure comprising:
means for transporting an array of articles between operating positions within the enclosure including circuit-connected, disconnected, and grounded positions; and
means for viewing the operating positions of the array of articles in at least the disconnected and grounded positions.

2. The control arrangement of claim 1 wherein said transporting means further comprises means for translating the array of articles from the disconnected position to a position outside the enclosure for access to the array of articles.

3. The control arrangement of claim 1 wherein the array of articles are electrical devices having defined operational states, the control arrangement further comprising means for detecting the operational states of the array of electrical devices in each of the operating positions.

4. The control arrangement of claim 3 wherein each of the electrical devices includes an internal operating member movable between operational state positions, said detecting means comprising means for sensing the operational state position of the internal operating members.

5. The control arrangement of claim 4 wherein said sensing means senses the operational state positions of the electrical devices utilizing optical transmitter and receptor facilities that are aligned with the electrical devices.

6. The control arrangement of claim 5 wherein said sensing means comprises a sensor pair of transmitter and receptor facilities for each operating position of the array of electrical devices.

7. The control arrangement of claim 6 wherein each of the electrical devices includes a shutter member carried by the internal operating member and facilities for providing two optical paths through the electrical device and past the shutter member in each of two operational state positions.

8. The control arrangement of claim 7 wherein said sensing means determines the operational state of the electrical devices via the presence of an optical signal in one optical path and the absence of an optical signal in the other optical path.

9. The control arrangement of claim 1 wherein the array of articles are electrical devices each including connection arrangements and the enclosure includes circuit connection arrangements arranged to cooperate and connect to respective connection arrangements of the electrical devices, said transporting means comprising means for mounting said electrical devices in a predetermined position so as to align and connect said electrical device connection arrangements and said circuit connection arrangements in a predetermined manner when the electrical devices are moved to the operating positions.
